(19) United States
(12) Patent Application Publication
(10) Pub. No.: US 2008/0057211 A1
(43) Pub. Date: Mar. 6, 2008

(54) METHODS FOR PLATING AND FABRICATION APPARATUS THEREOF

(75) Inventors: Chung-Hsien Chen, Taipei (TW); Chun-Chieh Lin, Taichung City (TW); Hung-Wen Su, Jhubei City (TW); Minghsing Tsai, Chu-Pei City (TW); Shau-Lin Shue, Hsinchu (TW)

Correspondence Address: DUANE MORRIS LLP;IP DEPARTMENT (TSMC), 30 SOUTH 17TH STREET, PHILADELPHIA, PA, 19103-4196, US

(73) Assignee: TAIWAN SEMICONDUCTOR MANUFACTURING CO., LTD., Hsin-Chu (TW)

(21) Appl. No.: 11/468,142

(22) Filed: Aug. 29, 2006

(51) Int. Cl. B05C 3/00; B05D 1/18; C25D 5/00

(52) U.S. Cl. 427/430.1; 118/400; 205/137

(57) ABSTRACT

A method for plating includes positioning a substrate facing a plating solution. The method also includes immersing the substrate into the plating solution while plating a layer of material over a surface of the substrate, wherein an immersion speed of the substrate is about 100 millimeters per second (mm/s) or more while at least one portion of the substrate contacts the plating solution.

### BACKGROUND OF THE INVENTION

1. Field of the Invention

The present invention relates to semiconductor methods and fabrication apparatus thereof, and more particularly to methods for plating and fabrication apparatus thereof.

2. Description of the Related Art

With advances associated with electronic products, semiconductor technology has been widely applied in manufacturing memories, central processing units (CPUs), liquid crystal displays (LCDs), light emission diodes (LEDs), laser diodes and other devices or chipsets. In order to achieve high-integration and high-speed goals, dimensions of semiconductor integrated circuits continue to shrink. Various materials and techniques have been proposed to achieve these integration and speed goals and to overcome manufacturing obstacles associated therewith. In order to achieve these targets, copper (Cu) technology has been used in highly integrated circuits to reduce resistance of metal structures therein.

FIG. 1 is a schematic cross-sectional view showing a prior art method for electrical plating a copper layer over a substrate. A substrate 100 is held by a substrate holder 120. A shaft 130 is configured to move, rotate and tilt the substrate 100 held by the substrate holder 120. During an electrical plating process, a current is applied to the substrate 100 via the shaft 130. The substrate holder 120 holding the substrate 100 is moved toward a plating solution 115 confined within a plating cell 110 in the direction indicated by the arrow 140, while the substrate 100 is rotated and tilted to an angle with respect to the surface of the plating solution 115. Generally, the immersion speed of the substrate 100 is less than 100 millimeters per second (mm/s). The plating solution 115 is provided for electroplating a layer of copper on the surface of the substrate 100. Because the substrate 100 is tilted with an angle, the portion 100a of the substrate 100 is immersed in the plating solution 115 earlier than the remaining portion of the substrate 100. The portion 100a is generally referred to as the “immersion side” of the substrate 100 and subjected to the electrical plating process first.

The material begins being plated on the surface of the substrate 100 when the portion 100a of the substrate 100 touches the top surface of the plating solution 115, because a current path is provided from an anode of a power supply (not shown), the plating cell 110, plating solution 115, immersed portion 100a, substrate holder 120, shaft 130 to a cathode of the power supply (not shown). Once the portion 100a of the substrate 100 touches the top surface of the plating solution 115, charge carriers will crowd at the portion 100a due to its small area. A vigorous electrochemical reaction occurs at the portion 100a of the substrate 100, resulting in fast copper plating on the portion 100a. The fast plated copper on the portion 100a is non-uniform and rough. This is generally referred to as “hazy phenomenon.” When the immersion speed of the substrate 100 is reduced, this phenomenon becomes worse, because charge carriers will crowd at the portion 100a longer.

From the foregoing, plating methods and plating apparatus thereof are desired.

### SUMMARY OF THE INVENTION

In accordance with some exemplary embodiments, a method for plating comprises the steps of: (a) positioning a substrate facing a plating solution; and (b) immersing the substrate into the plating solution while plating a layer of material over a surface of the substrate, wherein an immersion speed of the substrate is about 100 millimeters per second (mm/s) or more while at least one portion of the substrate contacts the plating solution.

In accordance with some exemplary embodiments, an apparatus for plating comprises an enclosure, a plating cell, a substrate holder, a shaft and an actuator. The plating cell comprises a plating solution introduced therein. The enclosure is operable toward the plating cell. The substrate holder is disposed within the enclosure and operable facing toward the plating cell. The shaft is configured to perform at least one function comprising moving, rotating and tilting the substrate holder. The actuator is coupled to the shaft, wherein the actuator is configured to actuate the shaft to move the substrate holder toward the plating cell with a relative speed about 100 millimeters per second (mm/s) or more, while at least one portion of the substrate contacts the top surface of the plating solution.

The above and other features of the present invention will be better understood from the following detailed description of the preferred embodiments of the invention that is provided in connection with the accompanying drawings.

### BRIEF DESCRIPTION OF THE DRAWINGS

Following are brief descriptions of exemplary drawings. They are mere exemplary embodiments and the scope of the present invention should not be limited thereto.

FIG. 1 is a schematic cross-sectional view showing a prior art method for electrically plating a copper layer over a substrate.

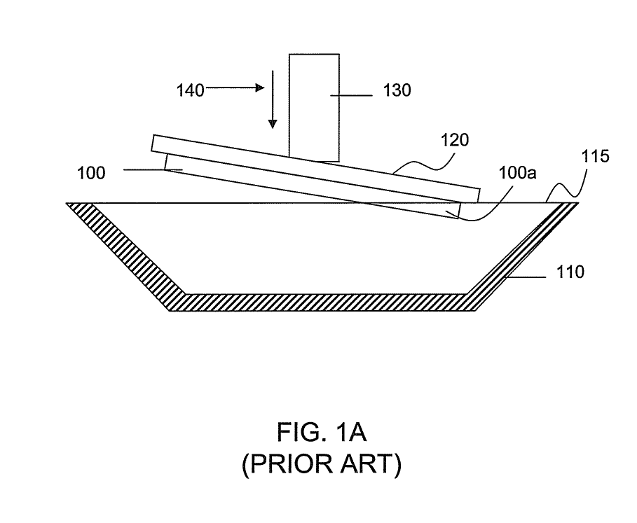

FIG. 2A is a schematic cross-sectional view of an exemplary plating apparatus.

FIG. 2B is a schematic cross-sectional view of another exemplary plating apparatus.

FIG. 3 is a flowchart showing an exemplary plating process.

### DESCRIPTION OF THE PREFERRED EMBODIMENT

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation.

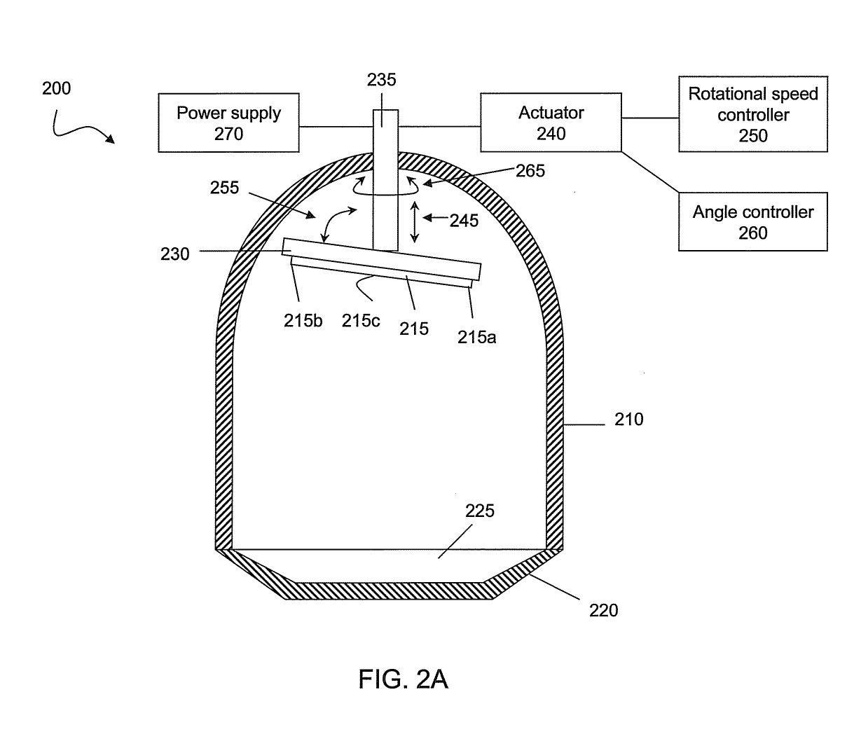

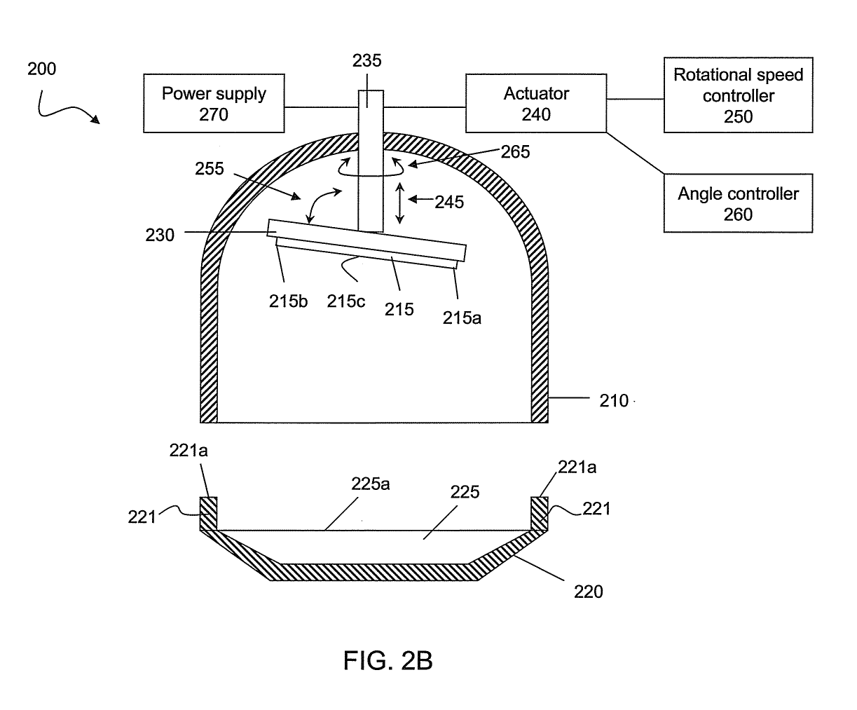

FIG. 2A is a schematic cross-sectional view of an exemplary plating apparatus. A plating apparatus 200 is provided for electrochemical plating or electroless plating, for example. In some embodiments, the plating apparatus 200 comprises an enclosure 210, a plating cell 220, a substrate holder 230, a shaft 235 and an actuator 240. The enclosure 210 comprises an opening (not shown) corresponding to the plating cell 220. The opening provides a path through which a substrate, such as substrate 215, can be loaded to or unloaded from the substrate holder 230. The substrate 215 can be a silicon substrate, III-V compound substrate, display substrate such as a liquid crystal display (LCD), plasma display, electro luminescence (EL) lamp display, or light emitting diode (LED) substrate (collectively referred to as, substrate 215), for example. In some embodiments, the substrate 215 comprises a structure (not shown), such as a via/contact hole or a dual-damascene opening, upon which a layer of material, such as copper or other plating material, is to be formed.

The enclosure 210 is operable toward the plating cell 220. In some embodiments, the enclosure 210 is connected with the plating cell 220 as shown in FIG. 2A. For example, the enclosure 210 is fixed and the plating cell 220 is configured to seal the opening of the enclosure 210; the plating cell 220 is fixed and the enclosure 210 is configured to connect with the plating cell 220 to seal the opening of the enclosure 210; or both of the enclosure 210 and plating cell 220 are operable toward each other so that the plating cell 220 can be connected with the enclosure 210 to seal the opening of the enclosure 210. In other embodiments, the enclosure 210 is not connected with the plating cell 220. For example, the enclosure 210 and the plating cell 220 do not seal the opening of the enclosure 210. The plating cell 220 may have a sidewall 221 whose top surface 221a is higher than a surface 225a of a plating solution 225 as shown in FIG. 2B.

The plating cell 220 comprises a space (not shown) for accommodating the plating solution 225 so that a plating process can be performed therein. In some embodiments, the plating cell 220 comprises at least one valve (not shown) coupled to a delivery system (not shown) for introducing and/or draining the plating solution 225 into and/or from the plating cell 220. The plating solution 225 comprises chemical of a material that is to be plated over the surface 215c of the substrate 215. In some embodiments, the plating solution may comprise a catholyte solution including a desired amount of acid, halides, supporting electrolyte, additives and/or other components.

The substrate holder 230 is disposed within the enclosure 210 and operable facing toward the plating cell 220. The substrate holder 230 comprises, for example, a clamp, knob clamp, clip, electrostatic chuck, or other device that is adapted to fasten the substrate 215 to the substrate holder 230. The shaft 235 is configured to move (translate), rotate and/or tilt the substrate holder 230.

The actuator 240 is coupled to the shaft 235. The actuator 240 can be, for example, a motor driving device to move (i.e., translate), rotate and/or tilt the substrate holder 215. In some embodiments, the actuator 240 comprises, for example, a motor (not shown) to actuate the shaft 235. The actuator 240 is adapted to actuate the shaft 235 to move the substrate holder 215 toward the plating cell 220 with a relative speed of about 100 millimeters per second (mm/s) or more in the directions indicated by double-sided arrow 245, for example.

In some embodiments, the plating apparatus 200 further comprises a rotational speed controller 250. The rotational speed controller 250 is coupled to the actuator 240 and can transmit a signal to the actuator 240 to rotate the substrate holder 230 (about a normal to a surface of the substrate) with a rotational speed between about 5 revolutions per minute (rpm) and about 90 rpm in the direction indicated by arrow 265, for example. In some embodiments, the plating apparatus 200 further comprises an angle controller 260. The angle controller 260 is coupled to the actuator 240 and can transmit a signal to the actuator 240 to tilt the substrate holder 230 to an angle between about 1° and about 5° with respect to the surface of the plating solution in the directions indicated by double-sided arrow 255, for example. In some embodiments, the plating apparatus 200 further comprises a power supply 270. The power supply 270 may be coupled to the substrate holder 230 via the shaft 235, for example. The power supply 270 may provide a current density between about 2.8 milliamperes per square centimeter (mA/cm²) and about 14 mA/cm² to the substrate holder 230 for electrical plating.

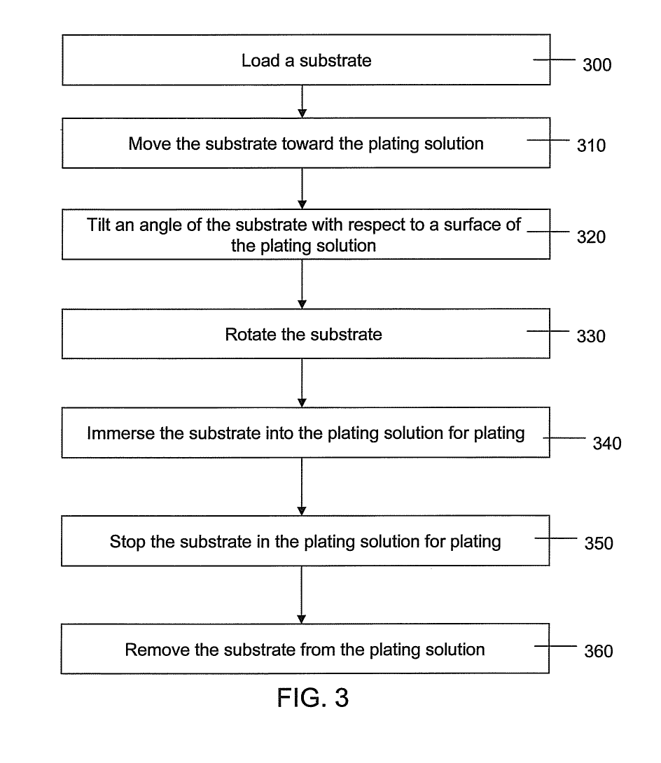

FIG. 3 is a flowchart showing an exemplary plating process. In step 300, a substrate, e.g., the substrate 215 shown in FIG. 2A, is loaded to the substrate holder 230 (shown in FIG. 2A). As described above, the substrate 215 can be fastened to the substrate holder 230 by a clamp, for example.

In step 310, the actuator 240 (shown in FIG. 2A) actuates the shaft 235 to move the substrate 215 held by the substrate holder 230 toward the top surface of the plating solution 225 filled within the plating cell 220. During this step, the substrate 215 has not yet touched or been immersed into the plating solution 225. In some embodiments, the surface 215c of the substrate 215 is substantially parallel to the top surface of the plating solution 225 during the period of step 310. In some embodiments, the speed of the substrate 215 held by the substrate holder 230 moved by the shaft 235 toward the top surface of the plating solution 225 is about 50 mm/s during this period.

In step 320, the angle controller 260 transmits a signal to the actuator 240 to actuate the shaft 235 to tilt the substrate holder 230 so that the surface 215c of the substrate 215 facing the plating solution 225 has an angle between about 1° and about 5° with respect to the top surface of the plating solution 225.

In step 330, the rotational speed controller 250 transmits a signal to the actuator 240 to actuate the shaft 235 to rotate the substrate holder 230 so that the substrate 215 is rotated about a normal to a surface of the substrate with a speed between about 5 revolutions per minute (rpm) and about 90 rpm.

In some embodiments, the sequence of steps 310-330 is adjustable. For example, step 330 may be performed before step 320. In other embodiments, at least two of the three steps can be performed at approximately the same time. In some embodiments, steps 320 and 330 are not performed until the substrate 215 contacts or is immersed into the plating solution 225.

In step 340, the substrate 215 is immersed into the plating solution 225 for plating. In some embodiments, the immersion speed of the substrate 215 held by the substrate holder 230 is about 100 mm/s or more, as soon as at least one portion, e.g., portion 215a, of the substrate 215 contacts the plating solution 225. The portion 215a of the substrate 215 may be, for example, a point or small area at which the substrate 215 contacts the top surface of the plating solution 225. The immersion speed of the substrate 215 can be, for example, gradually increased from the speed, e.g., of about 50 mm/s, described in step 310 to the speed of about 100 mm/s or more. The substrate 230 is then completely immersed into the plating solution 225 with the speed of about 100 mm/s or more until the last portion, e.g. portion 215b, of the substrate 215 is immersed under the top surface of the plating solution 225.

In some embodiments, the immersion speed of the substrate 215 is between about 100 mm/s and about 120 mm/s during the period between the time the portion 215a of the substrate 215 begins contacting the top surface of the plating solution 225 and the time when the whole surface 215c of the substrate 215 is immersed under the top surface of the plating solution 225. In some embodiments of electrical plating, the power supply 270 provides a current density between about 4.2 mA/cm² and about 8.4 mA/cm² during this period. Because the immersion speed of the substrate 215 is higher than about 100 mm/s, the period during which current crowds on the portion 215a of the substrate 215 is sufficiently short so that the hazy phenomenon described above can be effectively reduced or prevented. In some embodiments, the hazy phenomenon can be further reduced or prevented by rotating the substrate 215 with a speed between about 5 revolutions per minute (rpm) and about 90 rpm. By rotating the substrate 215, the portion of the substrate 215 contacting the plating solution 225 is rotated so that the charge carriers will not crowd at the same region, i.e., the hazy phenomenon will not occur at the same area.

In some embodiments, the substrate 215 is titled by the shaft 235 so that the surface 215c of the substrate 215 has an angle between about 1° and about 5° with respect to the surface of the plating solution 225, while the portion 215a contacts the top surface of the plating solution 225. The substrate 215 is tilted to reduce or prevent bubbles within the plating solution 225 from being blocked under the surface 215c of the substrate 215. The bubbles may be created by, for example, a plating solution delivery system (not shown) which introduces the plating solution 225 into the plating cell 220. The bubbles may be blocked under the surface 215c of the substrate 215, while the substrate 215 is being immersed into the plating solution 225. The bubbles may adversely affect physical uniformity and/or electrical characteristics of the material plated on the surface 215c of the substrate 215, specifically at a region where devices or circuits with feature sizes are formed. In still other embodiments, the substrate 215 is immersed into the plating solution 225 in such a way that the surface 215c of the substrate 215 is substantially parallel to the top surface of the plating solution 225 as long as the bubbles within the plating solution 225 are not a concern.

In some embodiments, the immersion speed of the substrate 215 is between about 120 mm/s and about 400 mm/s during the period between the time when the portion 215a of the substrate 215 begins contacting the top surface of the plating solution 225 and the time when the whole surface 215c of the substrate 215 is immersed under the top surface of the plating solution 225. For electrical plating, the power supply 270 may provide a current density between about 4.2 mA/cm² and about 8.4 mA/cm² to the substrate 215, for example. In some embodiments, the surface 215c of the substrate 215 may be substantially parallel to the top surface of the plating solution 225 because the immersion speed of the substrate 215 is sufficiently high so that bubbles within the plating solution 225 may not be blocked under the surface 215c of the substrate 215. Accordingly, the substrate 215 is not tilted.

Further, due to the high immersion speed, e.g., between about 120 mm/s and about 400 mm/s, rotation of the substrate 215 may be omitted, because the substrate 215 can be immersed into the plating solution 225 in a short period of time, so that current crowding described above can be reduced or prevented. Accordingly, the hazy phenomenon described above can be effectively reduced or prevented. In these embodiments, steps 320 and 330 described above are omitted.

In other embodiments, the substrate 215 fastened by the substrate holder 230 is rotated between about 5 rpm and about 90 rpm in order to reduce or prevent current crowing effect as described above. In still other embodiments, the substrate 215 may be tilted so that the surface 215c of the substrate 215 has an angle between about 1° and about 5° with respect to the surface of the plating solution 225. The inventor has determined that in some embodiments, for a given motor, the tilt angle of the substrate 215 is correlated with the immersion speed of the substrate 215. For example, assume the tilt angle is 2° and the immersion speed is 300 mm/s. If the substrate 215 is tilted to an angle of about 4°, the immersion speed is reduced to 150 mm/s, i.e., the larger the tilt angle, the slower the immersion speed. Accordingly, a large tilt angle, e.g., more than 5°, may affect the immersion speed of the substrate 215.

In step 350, the actuator 240 stops moving the substrate 215 so that the substrate 215 is immersed in the plating solution 225 for plating. During the period that the whole surface 215c of the substrate 215 is immersed under the top surface of the plating solution 225, and the moving of the substrate 215 stops, the immersion speed of the substrate 215 can be gradually reduced to zero, for example. In other embodiments, after being immersed in the plating solution 225, the actuator 240 maintains substantially the same immersion speed applied to the substrate 215 as set forth in connection with step 340 for a period of time, and then the immersion speed of the substrate 215 is gradually reduced to zero.

In step 360, after a desired layer of material is plated over the substrate 215, the actuator 240 removes the substrate 215 from the plating solution 225.

Although the present invention has been described in terms of exemplary embodiments, it is not limited thereto. Rather, the appended claims should be construed broadly to include other variants and embodiments of the invention which may be made by those skilled in the field of this art without departing from the scope and range of equivalents of the invention.

What is claimed is:

1. A method for plating, comprising the steps of:
(a) positioning a substrate facing a plating solution; and
(b) immersing the substrate into the plating solution while plating a layer of material over a surface of the substrate, wherein an immersion speed of the substrate is about 100 millimeters per second (mm/s) or more while at least one portion of the substrate contacts the plating solution.

2. The method of claim 1, wherein the immersion speed of the substrate is about 100 mm/s during a period between a time when the portion of the substrate contacts the plating solution and a time when the whole substrate is immersed into the plating solution.

3. The method of claim 1, wherein the immersion speed is between about 120 mm/s and about 400 mm/s, and a surface of the substrate is substantially parallel to the surface of the plating solution.

4. The method of claim 1, wherein the immersion speed is between about 100 mm/s and about 120 mm/s.

5. The method of claim 4 further comprising rotating the substrate with a speed between about 5 revolutions per minute (rpm) and about 90 rpm, while the portion of the substrate contacts the plating solution.

6. The method of claim 1 further comprising tilting the substrate to an angle between about 1° and about 5° with respect to the surface of the plating solution, while the portion of the substrate contacts the plating solution.

7. The method of claim 1 further comprising applying a current density between about 2.8 milliamperes per square centimeter (mA/cm²) and about 14 mA/cm², while the portion of the substrate contacts the plating solution.

8. A method for chemical plating, comprising the steps of:
positioning a substrate facing a plating solution;
tilting the substrate to an angle between about 1° and about 5° with respect to the surface of the plating solution;
immersing the substrate into the plating solution, wherein an immersion speed of the substrate is about 100 millimeters per second (mm/s) or more during a period between a time when at least one portion of the substrate contacts the plating solution and a time when the whole substrate is immersed into the plating solution; and
applying a current density between about 2.8 milliamperes per square centimeter (mA/cm²) and about 14 mA/cm² during the period.

9. The method of claim 8, wherein the immersion speed is between about 120 mm/s and about 400 mm/s.

10. The method of claim 8, wherein the immersion speed is between about 100 mm/s and about 120 mm/s.

11. The method of claim 10 further comprising rotating the substrate around a normal to a surface of the substrate with a speed between about 5 revolutions per minute (rpm) and about 90 rpm during the period.

12. An apparatus for plating, comprising:
a plating cell comprising a plating solution therein,
an enclosure operable toward the plating cell;
a substrate holder disposed within the enclosure, operable facing toward the plating cell;
a shaft configured to perform at least one function comprising translating, rotating and tilting the substrate holder; and
an actuator coupled to the shaft, wherein the actuator is configured to actuate the shaft to move the substrate holder toward the plating cell with a relative speed of about 100 millimeters per second (mm/s) or more, while at least one portion of the substrate contacts the top surface of the plating solution.

13. The apparatus of claim 12, wherein the actuator is configured to actuate the shaft to move the substrate holder toward the plating cell with a relative speed between about 120 mm/s and about 400 mm/s.

14. The apparatus of claim 12, wherein the actuator is configured to actuate the shaft to move the substrate holder toward the plating cell with a relative speed between about 100 mm/s and about 120 mm/s.

15. The apparatus of claim 14 further comprising a rotational speed controller coupled to the actuator, wherein the rotational speed controller is capable of controlling a rotational speed of the substrate holder between about 5 revolutions per minute (rpm) and about 90 rpm, while the portion of the substrate contacts the top surface of the plating solution.

16. The apparatus of claim 12 further comprising an angle controller coupled to the actuator, wherein the angle controller is capable of tilting a surface of the substrate holder to an angle between about 1° to about 5° with respect to the surface of the plating solution, while the portion of the substrate contacts the top surface of the plating solution.

17. The apparatus of claim 12 further comprising a power supply coupled to the substrate holder, wherein the power supply is capable of supplying a current density between about 2.8 milliamperes per square centimeter (mA/cm²) and about 14 mA/cm² to the substrate holder, while the portion of the substrate contacts the top surface of the plating solution.
